(19) United States
(12) Patent Application Publication
(10) Pub. No.: US 2005/0280726 A1
(43) Pub. Date: Dec. 22, 2005

(54) Image sensor for still or video photography

(75) Inventors: Christopher Parks, Rochester, NY (US); John T. Compton, LeRoy, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/871,288

(22) Filed: Jun. 18, 2004

(51) Int. Cl. H04N 9/04; H04N 9/083

(52) U.S. Cl. 348/282

(57) ABSTRACT

A method for reading out pixel values from an image sensor, the method includes obtaining an array of pixels alternating a first color row pattern and a second color row pattern; transferring the pixel values to a vertical charge-coupled device; summing at least two rows of the first color row pattern in a horizontal CCD and dumping at least one row of the second color row pattern; reading out the summed first color row pattern from the horizontal CCD; summing at least two rows of the second color row pattern in the horizontal CCD and dumping at least one row of the first color row pattern; reading out the summed second color row pattern from the horizontal CCD; and dumping two consecutive rows.

### FIELD OF THE INVENTION

The invention relates generally to the field of image sensors and, more particularly, a method for producing at least 15 frames per second (video) by reducing the resolution of an existing mega-pixel image sensor architecture by a factor of 4.

### BACKGROUND OF THE INVENTION

Referring to FIG. 1, an interline charge coupled device (CCD) image sensor 10 is comprised of an array of photodiodes 20. The photodiodes are covered by color filters to allow only a narrow band of light wavelengths to generate charge in the photodiodes. Referring to FIG. 2, typically image sensors having a pattern of three or more different color filters arranged over the photodiodes in a 2×2 sub array as shown in FIG. 2. For the purpose of a generalized discussion, the 2×2 array is assumed to have four colors, A, B, C, and D. The most common color filter pattern used in digital cameras, often referred to as the Bayer pattern, color A is blue, color B and C are green, and color D is red. Referring back to FIG. 1, image readout of the photo-generated charge begins with the transfer of some or all of the photodiode charge to the vertical CCD (VCCD) 30. In the case of a progressive scan CCD, every photodiode simultaneously transfers charge to the VCCD 30. In the case of a two field interlaced CCD, first the even numbered photodiode rows transfer charge to the VCCD 30 for first field image readout, then the odd numbered photodiode rows transfer charge to the VCCD 30 for second field image readout.

Charge in the VCCD 30 is read out by transferring all columns in parallel one row at a time into the horizontal CCD (HCCD) 40. The HCCD 40 then serially transfers charge to an output amplifier 50. The HCCD 40 may also utilize a second output amplifier 60 at the opposite end of the HCCD. If the HCCD is designed as commonly known pseudo 2-phase CCD the HCCD can transfer charge in two directions. Furthermore, the HCCD charge transfer direction may be in opposite directions from the center of the HCCD to the ends. The charge in the left half of the HCCD 40 would be transferred to the left output amplifier 50 and the charge in the right half of the HCCD 40 would be transferred to the right output amplifier 60. The use of two output amplifiers speeds up the image read out process by a factor of two. This type of HCCD has been employed on Kodak CCD image sensor products publicly available such as the Kodak products KAI-2020 and KAI-4020.

FIG. 1. shows an array of only 24 pixels. Many digital cameras for still photography employ image sensors having millions of pixels. A 6-megapixel image sensor would require at least ⅕ second to read out at a 40 MHz data rate. This is not suitable if the same camera is to be used for recording video. A video recorder requires an image read out in 1/30 second or faster. The shortcoming to be addressed by the present invention is how to reduce the resolution of a 6 mega pixel class image sensor by a factor of four for use as both a high quality digital still camera and 30 frames/second video camera.

The prior art addresses this problem by providing a video image at a reduced resolution (typically 640×480 pixels). For example, an image sensor with 3200×2400 pixels would be have only every fifth pixel read out as described in U.S. Pat. No. 6,342,921. This is often referred to as sub-sampling, or sometimes as thinned out mode or skipping mode. The disadvantage of sub-sampling the image by a factor of 5 is only 4% of the photodiodes are used. A sub-sampled image suffers from reduced photosensitivity and alias artifacts. If a sharp line focused on the image sensor is only on the un-sampled pixels, the line will not be reproduced in the video image. Other sub-sampling without summing schemes are described in U.S. Pat. Nos. 5,668,597 and 5,828,406.

Prior art U.S. Pat. No. 5,926,215 provides a method of summing two rows of like colors while dumping the row of different colors in between. The claims in this patent are only for the specific case of reducing the vertical resolution by a factor of three. A factor of 4 or larger vertical resolution reduction is required for 6 mega pixel or larger imagers.

Prior art including U.S. Pat. No. 6,661,451 or U.S. patent application publication 20020135689A1 attempt to resolve the problems of sub-sampling by summing pixels together. However, this prior art still leaves some pixels un-sampled and requires more than 2 VCCD clock drivers.

U.S. patent application publication 20030067550A1 reduces the image resolution vertically and horizontally for even faster image readout. However, this prior art requires a striped color filter pattern (a 3×1 color filter array), which is generally acknowledged to be inferior to the Bayer or 2×2 color filter array patterns.

Another disadvantage of the prior art is the number of VCCD clock drivers require is greater than 2. Sometimes as many as 8 or more VCCD clock drivers are required which increases camera design complexity.

If view of the deficiencies of the prior art, an invention is desired which is able to produce 30 frames/second video from a 6 mega pixel image sensor with a 2×2 color filter pattern while employing only 2 VCCD clock drivers and sampling 50% of the pixel array and reading out the video image progressive scan (non-interlaced). Of particular advantage is the invention may be implemented using already available image sensor products.

### SUMMARY OF THE INVENTION

The present invention is directed to overcoming one or more of the problems set forth above. Briefly summarized, according to one aspect of the present invention, the invention resides in a method for reading out pixel values from an image sensor, the method comprising obtaining an array of pixels alternating a first color row pattern and a second color row pattern; transferring the pixel values to a vertical charge-coupled device; summing at least two rows of the first color row pattern in a horizontal CCD and dumping at least one row of the second color row pattern; reading out the summed first color row pattern from the horizontal CCD; summing at least two rows of the second color row pattern in the horizontal CCD and dumping at least one row of the first color row pattern; reading out the summed second color row pattern from the horizontal CCD; and dumping two consecutive rows.

### ADVANTAGEOUS EFFECT OF THE INVENTION

The present invention includes the advantage of producing 30 frames per second video from a 6-mega pixel image sensor while sampling 50% of the entire pixel array.

### BRIEF DESCRIPTION OF THE DRAWINGS

FIG. 1 is a prior art image sensor;

FIG. 2 is a typical color filter array for image sensors;

FIG. 3 is a top view of a prior art image sensor;

FIG. 4 is a detailed, top view of a prior art pixel;

FIG. 5 is an overview illustration of initial reading out stages of the image sensor of the present invention;

FIG. 6 is another overview stage of the reading out of the image sensor of the present invention;

FIG. 7 is a detailed drawing of the reading out of the image sensor of the present invention;

FIG. 8 is another detailed drawing of the reading out of the image sensor of the present invention;

FIG. 9 is another detailed drawing of the reading out of the image sensor of the present invention;

FIG. 10 is another detailed drawing of the reading out of the image sensor of the present invention;

FIG. 11 is another detailed drawing of the reading out of the image sensor of the present invention;

FIG. 12 is another detailed drawing of the reading out of the image sensor of the present invention;

FIG. 13 is a detailed drawing of FIG. 12;

FIG. 14 is another detailed drawing of the reading out of the image sensor of the present invention;

FIG. 15 is another detailed drawing of the reading out of the image sensor of the present invention;

FIG. 16 is another detailed drawing of the reading out of the image sensor of the present invention;

FIG. 17 is another detailed drawing of the reading out of the image sensor of the present invention;

FIG. 18 is a detailed view of FIG. 17;

FIG. 19 is another detailed drawing of the reading out of the image sensor of the present invention;

FIG. 20 is another detailed drawing of the reading out of the image sensor of the present invention;

FIG. 21 is an illustration of color channels per pixel of the image sensor of the present invention;

FIG. 22 is an illustration of color channels per pixel of the image sensor of the present invention after interpolation and;

FIG. 23 is a side view of a digital camera for illustrating a typical commercial embodiment for the image sensor of the present invention.

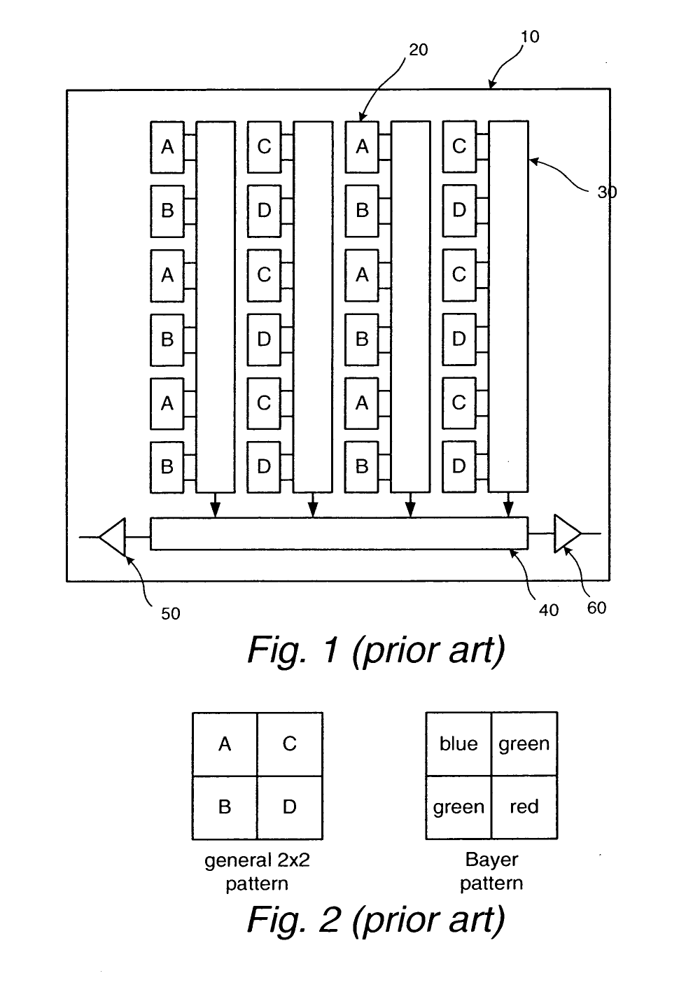

### DETAILED DESCRIPTION OF THE INVENTION

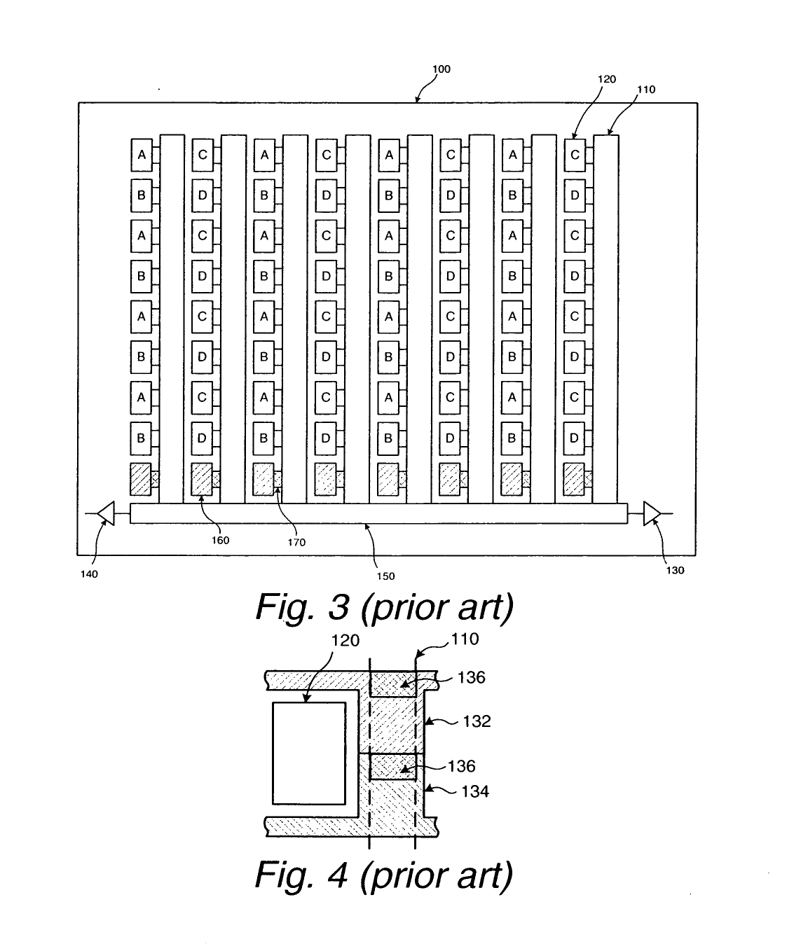

Referring to FIG. 3, there is shown the image sensor 100 used by the present invention. It is of the same architecture as the Kodak products KAI-2020 and KAI-4020. For clarity, only a small portion of the pixel array of the image sensor 100 is shown. It consists of an array of photodiodes 120 with VCCDs 110 positioned in between columns of photodiodes 120. There are color filters repeated in a 2×2 array spanning across the entire photodiode array. The 4 color filters A, B, C, and D are of 3 or 4 unique colors. The colors typically are, but not limited to, A=blue, B=C=green, D=red. Other common color schemes utilize cyan, magenta, and yellow or even white filters.

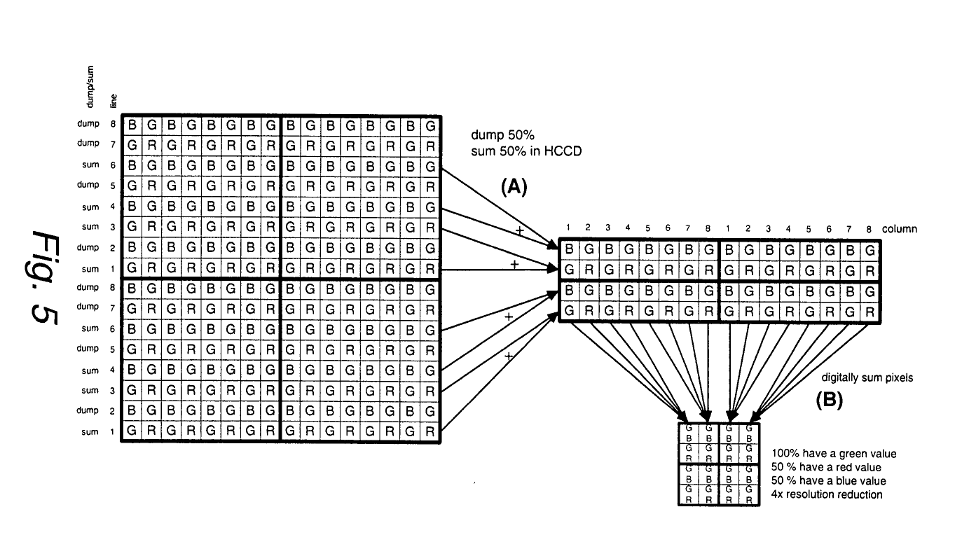

Referring briefly to FIG. 4, one pixel is shown. The buried channel VCCD 110 is of the interlaced 2-phase type with two control gate electrodes 132 and 134 per photodiode 120. Under each control gate electrode 132 and 134 there is a barrier implant 136 used to set the direction of charge transfer as is well known in the art for 2-phase CCD's.

Referring back to FIG. 3, the full resolution read out of an image stored in the photodiodes 120 proceeds in the below-described manner for a progressive image sensor 100. First the charge in all the photodiodes 120 is transferred to the adjacent VCCD 110. Once charge is in the VCCD 110, it is transferred in parallel towards a serial pseudo 2-phase HCCD 150. When operated in full resolution still photography mode the HCCD 150 is operated such that all charge packets are transferred towards the left output 140. The right output 130 is normally not used in full resolution mode. Using only the left output 140 eliminates problems associated with balancing the non-linearity of the two output amplifiers 130 and 140. When in video mode, and only 15 frames/second video is desired then only the left output 140 needs to be used. If 30 frames/second video is desired then the right half of the HCCD 150 reverses charge transfer direction towards the right output 130. Using both outputs 130 and 140 allows for approximately doubling the frame rate.

There is a dump drain 160 and a dump control gate 170 in the image sensor 100 for dumping (discarding) an entire row of charge from the VCCD 110 without having to use time to read the row out through the HCCD 150. The row of dump drains 160 speeds up image readout. For example if 50% of the rows are discarded into the dump drain 160 then the image read out is approximately twice as fast. Turning the dump control gate 170 on diverts charge from the VCCD 110 into the dump drain 160 instead of into the HCCD 150.

When the sensor is installed in a digital camera and is to be used in video mode, an external shutter (if present) is held open and the image sensor 100 is operated continuously. Most applications define video as a frame rate of at least 10 frames/sec with 30 frames/sec being the most desired rate. Currently, image sensors are typically of such high resolution that full resolution image readout at 30 frames/sec is not possible at data rates less than 50 MHz and one or two output amplifiers. The solution of the present invention is to reduce the vertical resolution by a factor of 4 or more in the image sensor and reduce the horizontal resolution by a factor of 4 or more after the output has been digitized. A factor of 4 reduction in resolution allows for 30 frames/second video (640×480 pixels) from a 6 million pixel image sensor.

First we present in FIG. 5 a schematic representation for an embodiment of the invention as applied to the Bayer color filter pattern. A 16×16 pixel subset of the entire image sensor array is shown. Of particular interest is an 8×8 pixel region of R (red), G (green), and B (blue) pixels in the Bayer pattern. FIG. 5 location (A) represents the dumping of lines 2, 5, 7 and 8. Lines 1 and 3 are summed together to form a row of R and G pixels. Lines 4 and 6 are summed together to form a row of B and G pixels. This summing process is accomplished by summing (sometimes called binning) two charge packets in the HCCD. This reduces the vertical resolution by a factor of 4. Other equivalent permutations of dumping and summing are possible.

At location (B) of FIG. 5 the horizontal resolution is digitally reduced by a factor of 4 (after charge packets have been read out of the output amplifiers). The digital summing sums together columns 1+3, 2+4, 5+7, and 6+8. The goal is to obtain red, green, and blue information at each pixel site to form a 3-color channel RGB triplet for full color display. For the G/R row of pixels the summed columns 1+3 form the G channel of an RGB color triplet, and the summed columns 2+4 form the R channel. The B channel of the RGB color triplet will be obtained by an average of the rows B channel above and below the G/R row. For the G/B row of pixels the summed columns 1+3 form the B channel of an RGB color triplet, and the summed columns 2+4 form the G channel. The R channel of the RGB color triplet will be obtained by an average of the rows R channel above and below the G/B row.

Other possibilities exist for the digital summing such as employing weighted averages of green pixels across a row to account for the one pixel offset of greens between even and odd rows. It is also possible to take the image just after readout from the image sensor (FIG. 5 location (A)), and perform the same Bayer color filter interpolation that would normally be applied to the full resolution image. Then after the Bayer color filter interpolation has produced an RGB color triplet at each pixel location, reduce the horizontal resolution by a factor of 4 to obtain an image of the proper aspect ratio.

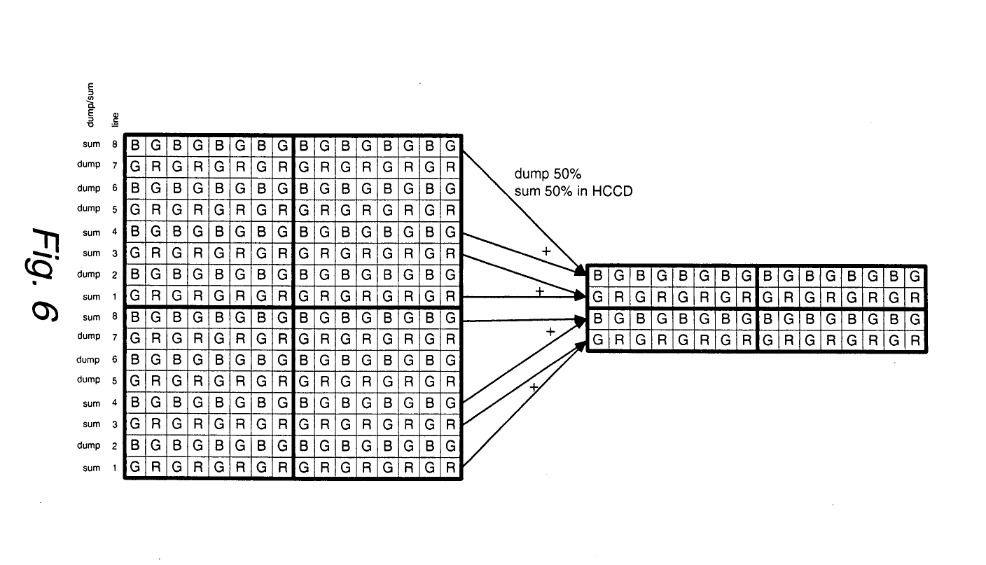

Another method of reducing the vertical resolution by a factor of 4 is shown in FIG. 6. Here lines 1+3 are summed while dumping line 2 as was also done in FIG. 5. The difference in FIG. 6 is for the second color filter patter containing green/blue lines 5+8 are summed while dumping the 3 consecutive lines 5 through 7. The method in FIG. 6 produces a 4× vertical resolution reduction using a constant sampling frequency of every 4^{th} row while FIG. 5 produces a 4× vertical resolution reduction using a constant aperture of 3 rows.

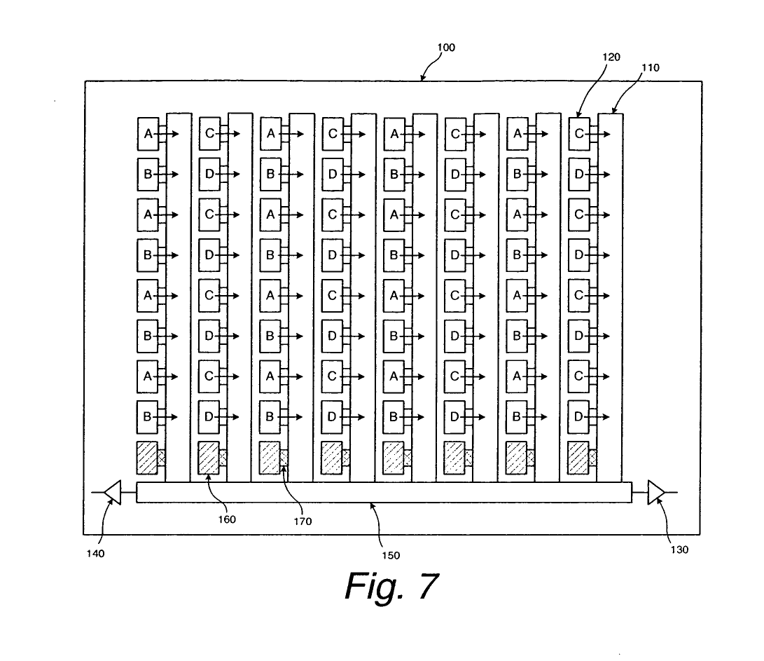

We will now discuss a more generalized and detailed flow of the charge transfer for the method as illustrated in FIG. 5. Beginning with FIG. 7, at the end of the image capture integration time all of the photodiodes 120 simultaneously transfer their charge to the light shielded VCCD 110. The start of the next image integration time may begin with this transfer is complete or may begin at a later time as initialed by an electronic shutter. The photodiodes are covered by color filters of at least three unique colors arranged in a 2×2 sub-array color filter pattern as indicated by the letters A, B, C, and D.

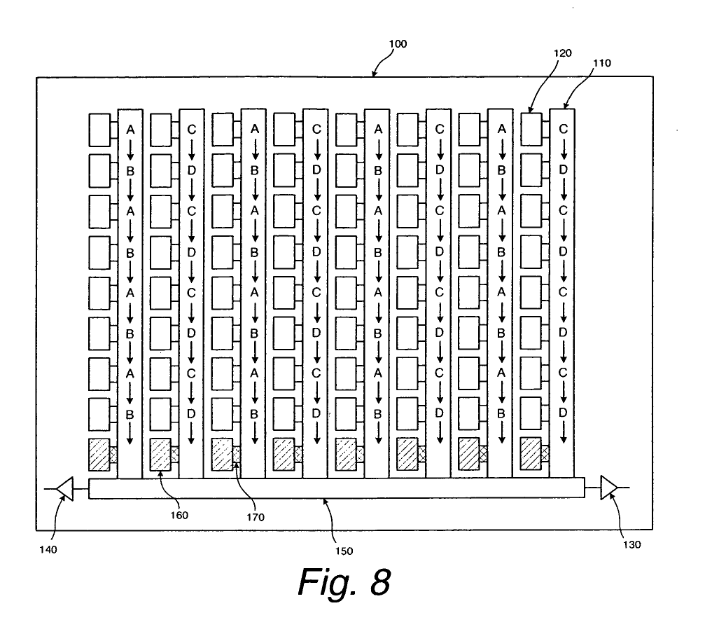

Next in FIG. 8 all of the charge packets are transferred down one row in the VCCD 110 towards the HCCD 150.

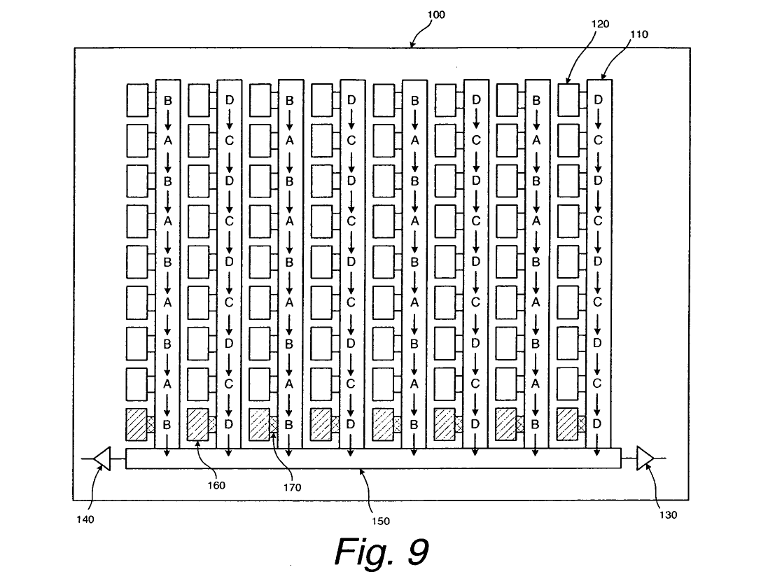

Next in FIG. 9 all of the charge packets are transferred down one row in the VCCD 110 towards the HCCD 150. The last row containing charge packets from photodiodes having color filters B and D are transferred into the HCCD 150. At this time the HCCD remains stopped and does not read out the charge packets.

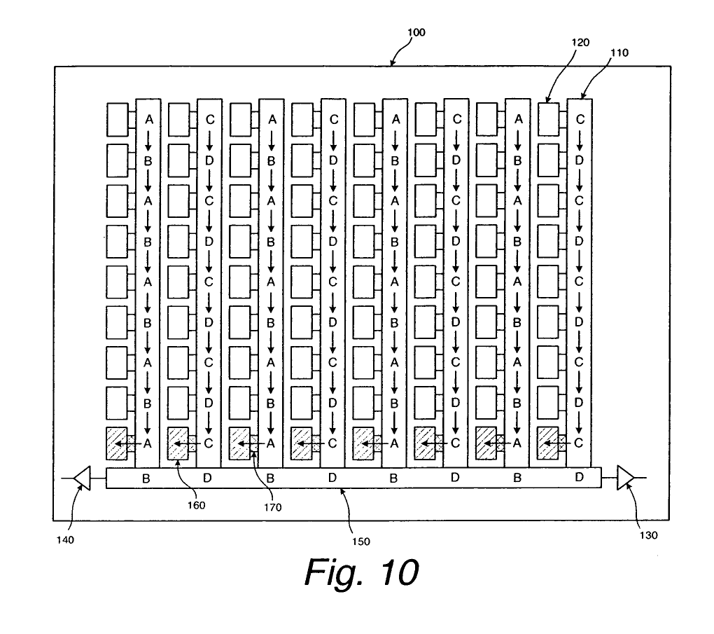

Next in FIG. 10 the dump drain control gate 170 is turned on and all charge packets in the VCCD 110 are transferred one row towards the HCCD 150. With the dump drain control gate 170 on, the row of charge packets corresponding to colors A and C are discarded to the drain 160. This prevents the mixing of two different colors in the HCCD 150.

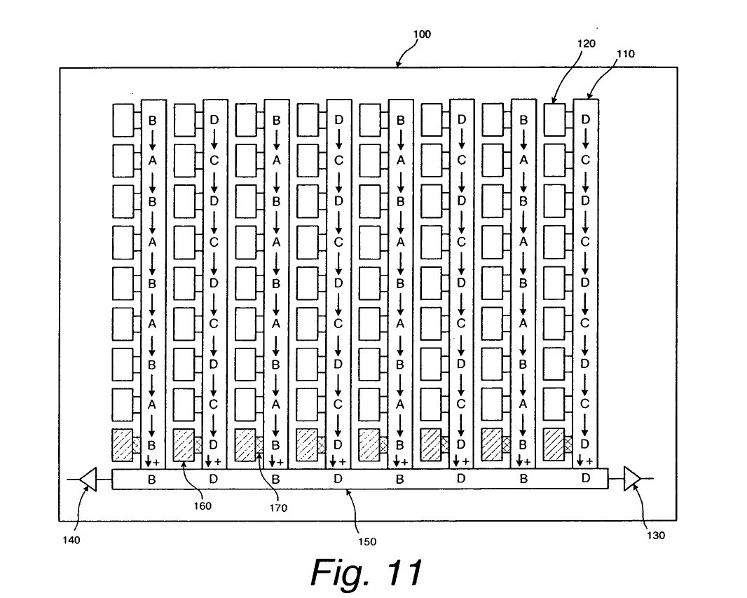

Next in FIG. 11 all of the charge packets are transferred down one row in the VCCD 110 towards the HCCD 150. The last row containing charge packets from photodiodes having color filters B and D are transferred into the HCCD 150 and summed together with the B and D charge packets already in the HCCD 150.

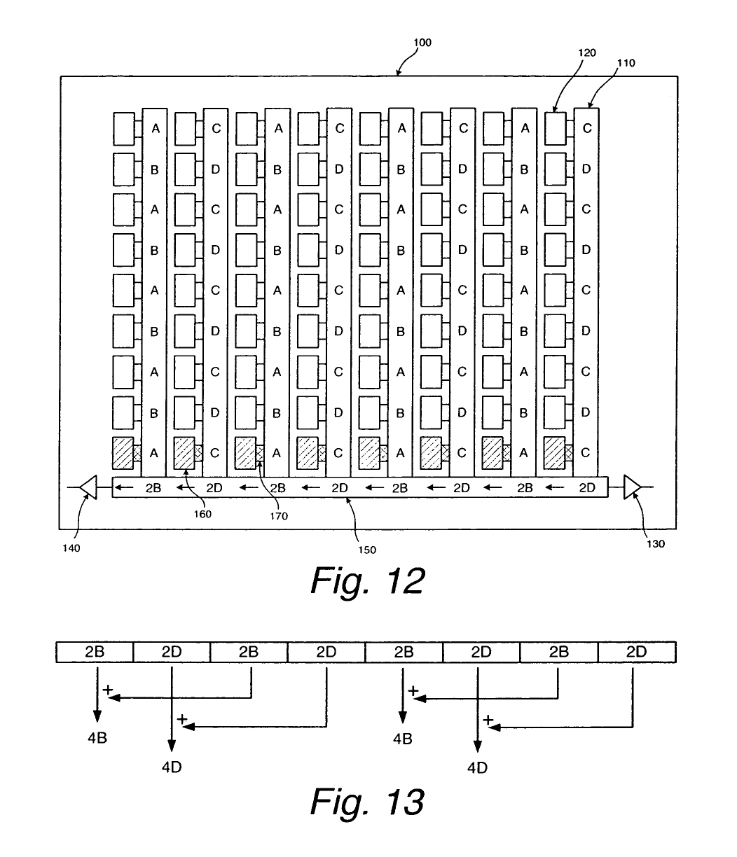

Next in FIG. 12 the summed charge packets in the HCCD 150 are transferred towards the left output amplifier 140. For faster read out half of the summed charge packets may be transferred towards the right output amplifier 130.

FIG. 13 details the read out of the HCCD 150. All charge packets are read out and digitized. In the digital domain two pairs of summed charge packets are added together to form the final values comprised of 4 B charge packets and 4 D charge packets. The two consecutive 4B and 4D values are used to form two of the 3-color channels required for display. The method is not limited to only summing two values together. A weighted average of three values may also be used.

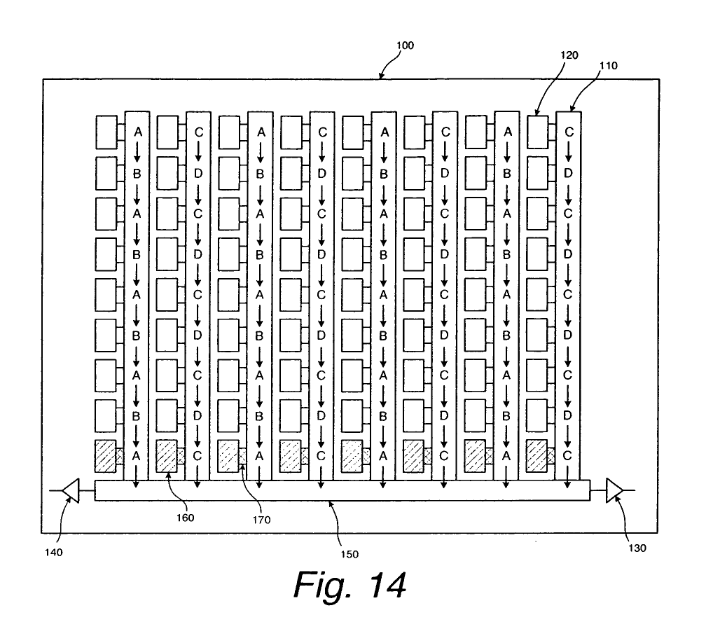

Next in FIG. 14 all of the charge packets are transferred down one row in the VCCD 110 towards the HCCD 150. The last row containing charge packets from photodiodes having color filters A and C are transferred into the empty HCCD 150.

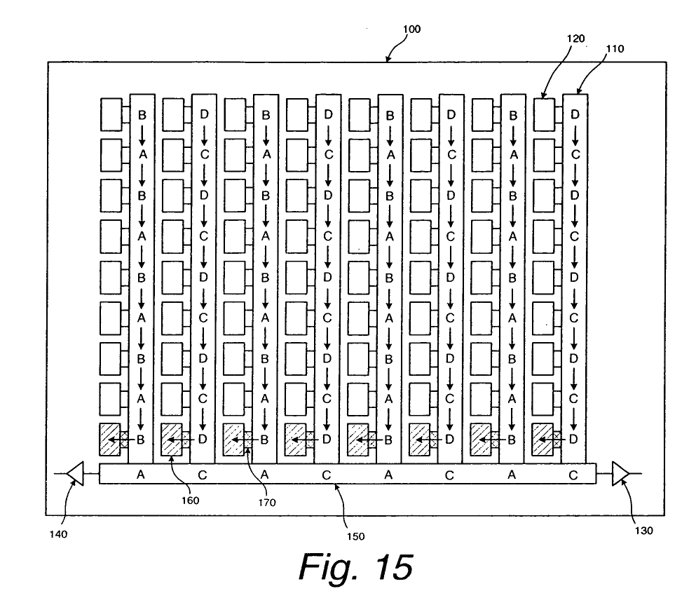

Next in FIG. 15 the dump drain control gate 170 is turned on and all charge packets in the VCCD 110 are transferred one row towards the HCCD 150. With the dump drain control gate 170 on the row of charge packets corresponding to colors B and D are discarded to the drain 160. This prevents the mixing of two different colors in the HCCD 150.

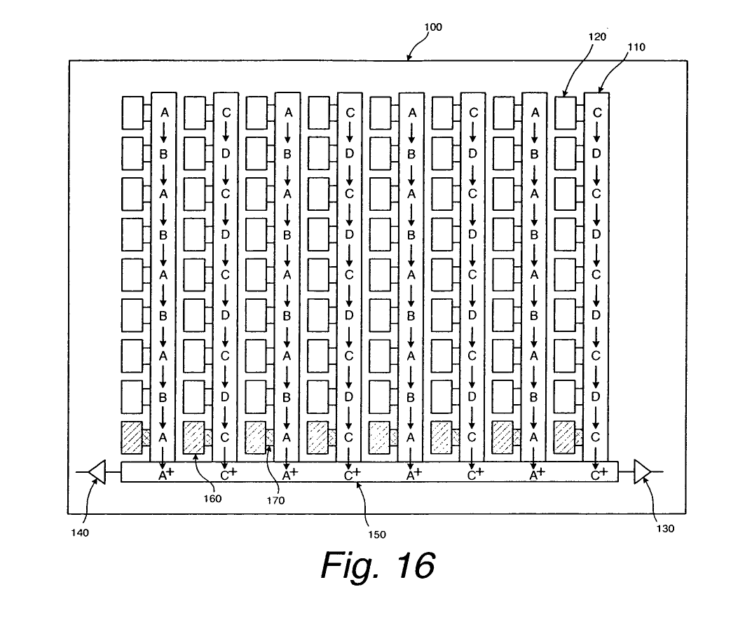

Next in FIG. 16 all of the charge packets are transferred down one row in the VCCD 110 towards the HCCD 150. The last row containing charge packets from photodiodes having color filters A and C are transferred into the HCCD 150 and summed together with the A and C charge packets already in the HCCD 150.

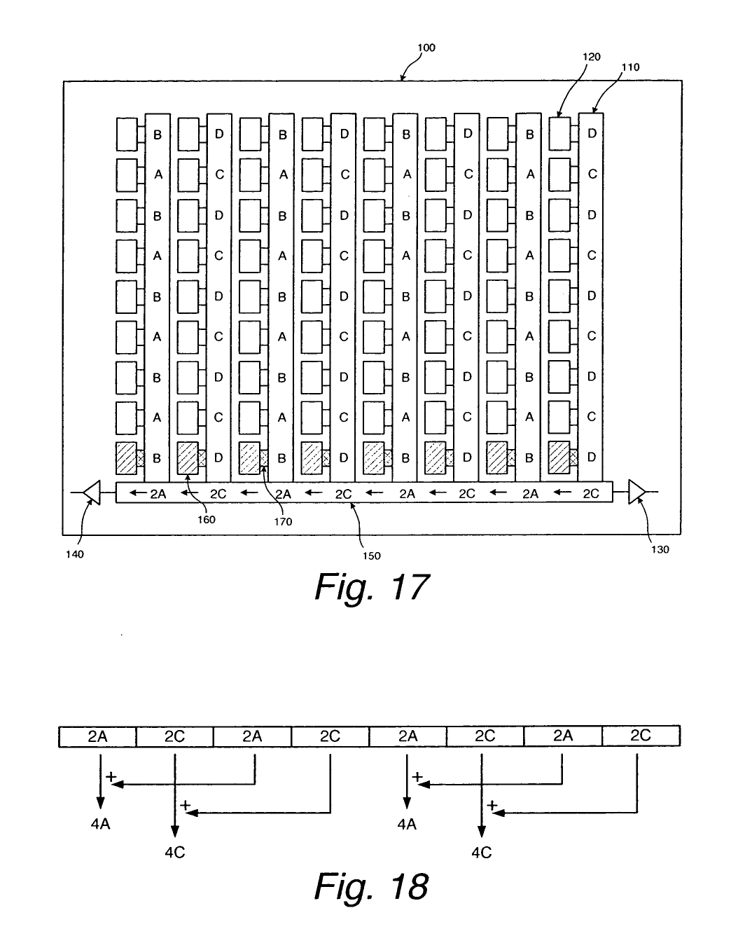

Next in FIG. 17 the summed charge packets in the HCCD 150 are transferred towards the left output amplifier 140. For faster read out half of the summed charge packets may be transferred towards the right output amplifier 130.

FIG. 18 details the read out of the HCCD 150. All charge packets are read out and digitized. In the digital domain two pairs of summed charge packets are added together to form the final values comprised of 4 A charge packets and 4 C charge packets. The two consecutive 4A and 4C values are used to form two of the 3-color channels required for display.

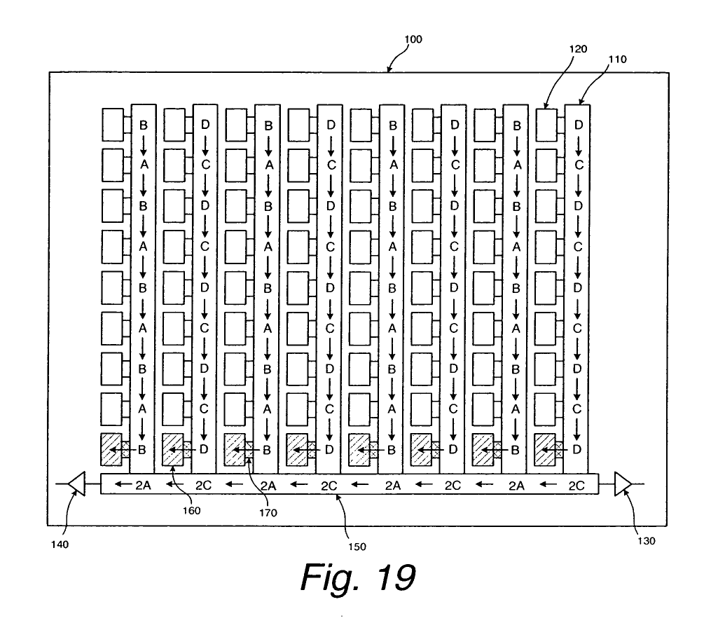

Next in FIG. 19 the dump drain control gate 170 is turned on and all charge packets in the VCCD 110 are transferred one row towards the HCCD 150. With the dump drain control gate 170 on the row of charge packets corresponding to colors B and D are discarded to the drain 160. This prevents the mixing of two different colors in the HCCD 150.

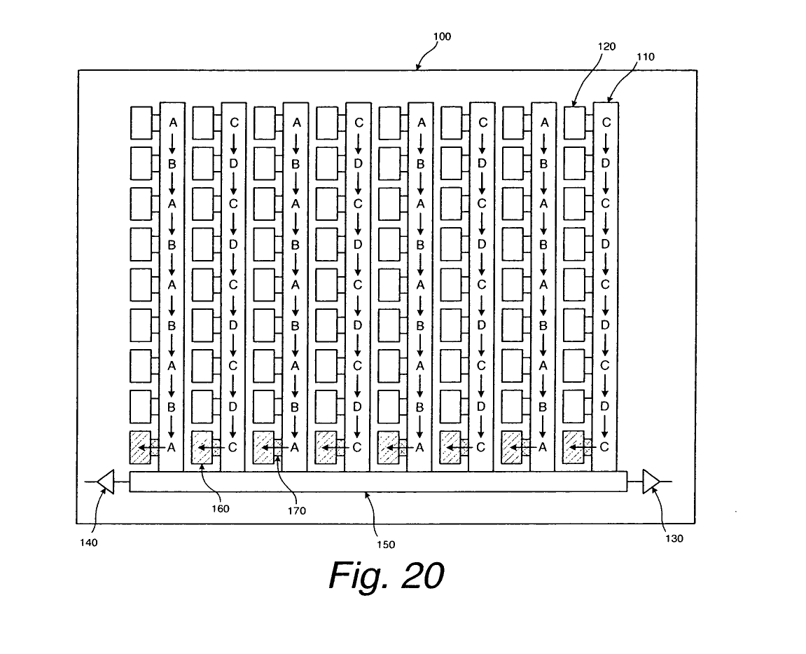

Next in FIG. 20 the dump drain control gate 170 is kept on and all charge packets in the VCCD 110 are transferred one row towards the HCCD 150. With the dump drain control gate 170 on the row of charge packets corresponding to colors A and C are discarded to the drain 160. This prevents the mixing of two different colors in the HCCD 150.

At this point in time two rows have been read out of the HCCD 150 for 8 row transfers in the VCCD 110. This represents a 4× reduction in vertical resolution. The process now loops back to FIG. 9 and is repeated until the entire image sensor 100 has been read out.

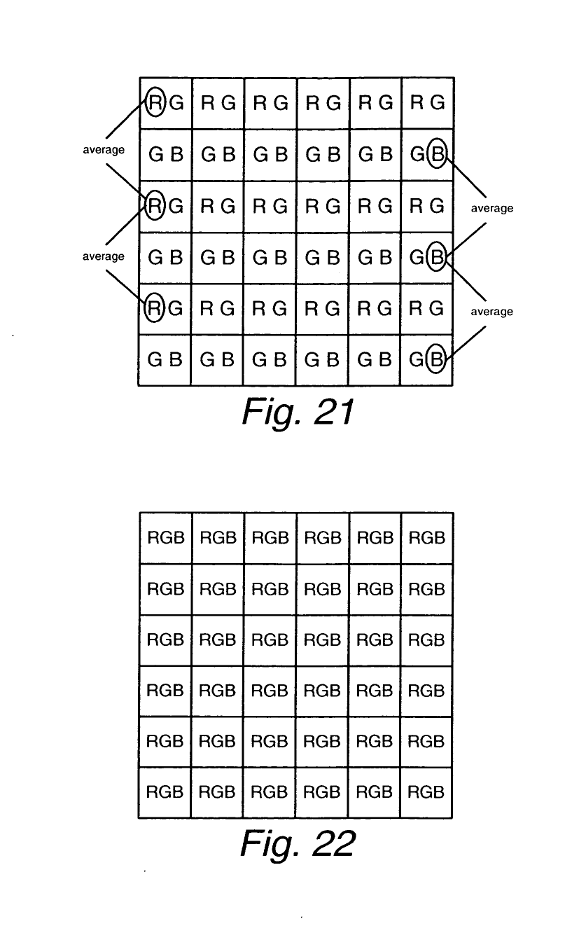

Now let us consider again the Bayer pattern where A=blue, B=C=green, D=red (note there are other equivalent permutations all having the characteristic that two of the four colors are green, one red, and one blue). The image read out procedure as described above for FIGS. 7 through 20 will produce an image of 4× less resolution (horizontally and vertically) with two color values per pixel as illustrated in FIG. 21. For image display three color values are required per pixel. All pixels have green (G) values. Every other row is missing either an R or B value. To fill in the missing values, the row missing a B value will obtain its B value by averaging the B values together from the rows above and below. Likewise, the row missing an R value will obtain its R value by averaging the R values together from the rows above and below. After this is done the final image will contain three color values at each pixel as shown in FIG. 22.

For the sake of a clear detailed discussion the invention has been described as providing a 4× vertical resolution reduction. 5× or higher vertical resolution reduction can be achieved by summing together additional rows of the first color filter pattern (row of green/red for example) and dumping rows of the second color filter pattern in between (rows of green/blue for example). Then switch over to summing rows of the second color filter pattern (green/blue) and dumping rows of the first color filter pattern (green/red).

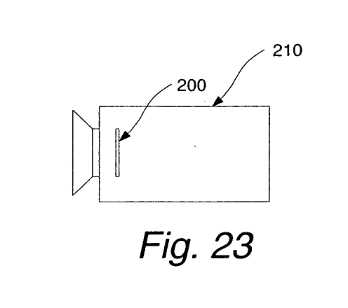

FIG. 23 shows an electronic camera 210 containing the image sensor 200 capable of video and high-resolution still photography as described earlier. In video mode 50 percent of all pixels are sampled. In still mode all pixels are sampled simultaneously for progressive scan readout with electronic shuttering. A mechanical shutter is optional.

1. A method for reading out pixel values from an image sensor, the method comprising:
(a) obtaining an array of pixels alternating a first color row pattern and a second color row pattern;
(b) transferring the pixel values to a vertical charge-coupled device;
(c) summing at least two rows of the first color row pattern in a horizontal CCD and dumping at least one row of the second color row pattern;
(d) reading out the summed first color row pattern from the horizontal CCD;
(e) summing at least two rows of the second color row pattern in the horizontal CCD and dumping at least one row of the first color row pattern;
(f) reading out the summed second color row pattern from the horizontal CCD; and
(g) dumping two consecutive rows.

2. The method as in claim 1 further comprising the step of repeating steps (c) through (g) until all rows are read out.

3. The method as in claim 1 further comprising the steps in the order of steps (c); (d); (e); (f) and (g).

4. The method as in claim 1 further comprising the step of summing at least two pixels within a row of a first color after readout from the horizontal CCD and summing at least two pixels within a row of a second color after readout from the horizontal CCD.

5. The method as in claim 1 further comprising the steps of defining a 2×2 sub-array of the pixels read from the horizontal CCD and interpolating the sub-array into a pixel having at least three color channels for further reducing the resolution.

6. A method for reading out pixel values from an image sensor, the method comprising:
(a) obtaining an array of pixels alternating a first color row pattern and a second color row pattern;
(b) transferring the pixel values to a vertical charge-coupled device;
(c) summing at least two rows of the first color row pattern in a horizontal CCD and dumping at least one row of the second color row pattern;
(d) reading out the summed first color row pattern from the horizontal CCD;
(e) summing at least two rows of the second color row pattern in the horizontal CCD and dumping at least three rows;
(f) reading out the summed second color row pattern from the horizontal CCD.

7. The method as in claim 6 further comprising the step of repeating steps (c) through (f) until all rows are read out.

8. The method as in claim 6 further comprising the steps in the order of steps (c); (d); (e); and (f).

9. The method as in claim 6 further comprising the step of summing at least two pixels within a row of a first color after readout from the horizontal CCD and summing at least two pixels within a row of a second color after readout from the horizontal CCD.

10. The method as in claim 6 further comprising the steps of defining a 2×2 sub-array of the pixels read from the horizontal CCD and interpolating the sub-array into a pixel having at least three color channels for further reducing the resolution.
